(19) United States
(12) Patent Application Publication
(10) Pub. No.: US 2021/0369037 A1
(43) Pub. Date: Dec. 2, 2021

(54) COOKER AND METHOD FOR FORMING GOLDEN PROTECTIVE LAYER THEREON

(71) Applicant: Hebei Sanxia Kitchenware Technology Co., Ltd., Xingtai (CN)

(72) Inventors: Guanghui HAN, Xingtai (CN); Jianguo WANG, Xingtai (CN)

(73) Assignee: Hebei Sanxia Kitchenware Technology Co., Ltd., Xingtai (CN)

(21) Appl. No.: 17/403,912

(22) Filed: Aug. 17, 2021

Related U.S. Application Data
(63) Continuation of application No. PCT/CN2021/081949, filed on Mar. 20, 2021.

(30) Foreign Application Priority Data
Mar. 21, 2020 (CN) 202010204058.3

(51) Int. Cl. A47J 27/00; A47J 36/02

(52) U.S. Cl. CPC A47J 27/002; A47J 36/02

(57) ABSTRACT

A method for forming the golden protective layer on the cooker includes: covering at least part of a surface of the cooker with vegetable oil including linseed oil, sintering the cooker with the vegetable oil on the surface at 180-300° C., and cooling the cooker to cause the vegetable oil to form the golden protective layer. The golden protective layer is formed on the cooker by the method of the present disclosure, which results in a surface of a finished cooker being golden yellow, and the color being full, uniform and bright, the cooker being more fashionable, healthier and more environment-friendly, and the golden protective layer having a much longer salt spray test duration, and being capable of passing a dishwasher test, thus realizing good oxidation resistance, rust prevention and surface protection for the cooker, and showing excellent rust resistance and long-term protection performance.

### BACKGROUND OF THE INVENTION

### 1. Technical Field

The present invention relates to the technical field of cooker manufacturing, in particular to a cooker and a method for forming a golden protective layer thereon.

### 2. Description of Related Art

Iron cookers are traditional cookware, and many families still use iron cookers to cook food. Iron cookers tend to oxidize and rust under humidity and other environment conditions during transportation and storage. One of the common methods to prevent rusting of an iron cooker is to cover the surface of the cooker with a layer of vegetable oil, so as to prevent moisture from making contact with an iron cooker body to cause rusting. However, this protection method has a problem that the applied vegetable oil oxidizes and deteriorates easily. Therefore, the applied vegetable oil has a weak anti-rusting ability and will lose its protection effect within a short time, which facilitates moisture permeation and rusting.

Another method to prevent iron cookers from rusting is to apply oil to the cast iron cooker, and then conduct heat treatment to form a black protective film on the surface of the cooker. The black protective film is used for protecting the iron cooker body. However, the salt spray test duration of the black protective film formed by heat treatment is generally 1:5-20 min, and the black protective film is not suitable for a dishwasher test and cannot pass a dishwasher test. The ability of the black protective film to block moisture is limited, and rusting will still occur during long-term transportation or storage of the cookers. In addition, the black protective film does not look good, thus failing to meet the requirement of modern users for an attractive appearance.

### BRIEF SUMMARY OF THE INVENTION

The invention provides a cooker and a method for forming a golden protective layer thereon to solve the above problems. By means of the method, a golden protective layer can be formed on a surface of the cooker. The golden protective layer has a much longer salt spray test duration, can pass a dishwasher test, and has great oxidation resistance and rust resistance during long-term transportation or storage. Compared with the black protective film, the golden protective layer has a brighter color and a more attractive appearance.

The invention is realized by adopting the following technical solution:

A method for forming a golden protective layer on a cooker comprises: covering at least part of a surface of the cooker with vegetable oil including linseed oil, sintering the cooker with the vegetable oil on the surface at 180-300° C., and cooling the cooker to cause the vegetable oil to form the golden protective layer.

In one embodiment, the cooker with the vegetable oil on the surface is sintered at 180-300° C. for 18-30 min.

In one embodiment, covering at least part of the surface of the cooker with the vegetable oil comprises: immersing the cooker in vegetable oil with a temperature of 20-40° C. for 1-10 sec, then taking out the cooker, and then preheating the cooker in an environment of 100-190° C.

In one embodiment, the cooker is preheated in the environment of 100-170° C. for 8-15 min.

In one embodiment, the thickness of the golden protective layer is 20-60 μm.

In one embodiment, the vegetable oil further comprises olive oil, safflower seed oil or soybean salad oil.

In one embodiment, the weight ratio of the linseed oil the olive oil is (7-9): (1-3).

In one embodiment, the weight ratio of the linseed oil to the safflower seed oil is (8-9): (1-2), and the weight ratio of the linseed oil to the soybean salad oil is (8-9): (1-2).

A cooker is provided, a golden protective layer is arranged on a surface of the cooker, and the golden protective layer is formed by the above method for forming the golden protective layer on the cooker.

In one embodiment, the cooker is an iron cooker.

Compared with the prior art, the invention at least has the beneficial effects that:

By means of the methods described above, the golden protective layer is formed on the cooker, a surface of a finished cooker is golden yellow, and the color is full, uniform and bright, making the cooker more fashionable, healthier and more environment-friendly; and the golden protective layer has a much longer salt spray test duration, and can pass a dishwasher test, thus realizing good oxidation resistance, rust prevention and surface protection for the cooker, and showing excellent rust resistance and long-term protection performance.

### BRIEF DESCRIPTION OF THE SEVERAL VIEWS OF THE DRAWINGS

FIG. 1 is a block diagram of a process for forming a golden protective layer on a cooker according to an embodiment of the present invention.

### DETAILED DESCRIPTION OF THE INVENTION

Example embodiments will now be described more fully with reference to the accompanying drawings. However, the example embodiments can be implemented in many forms and should not be construed as limited to the embodiments set forth herein; on the contrary, these embodiments are provided to make the present invention more comprehensive and complete, and to fully convey the concept of the example embodiments to those skilled in the art.

The present invention provides a cooker. A surface of the cooker is provided with a golden protective layer which uniformly and finely covers the surface of the cooker, has good oxidation resistance, rust resistance and surface protection functions, and has stronger corrosion resistance and machine washing resistance. When the golden protective layer is formed, the cooker is subjected to high temperature treatment, which reduces the internal stress of the cooker, improves the stability of an internal structure and enhances the flexibility of the cooker, so that the cooker does not deform or crack and has better applicability and longer service life. A surface of a. finished cooker is golden yellow, and the color is full, uniform and bright, making the cooker more fashionable, healthier and more environment-friendly. Rust resistance and long-term protection performance are improved greatly.

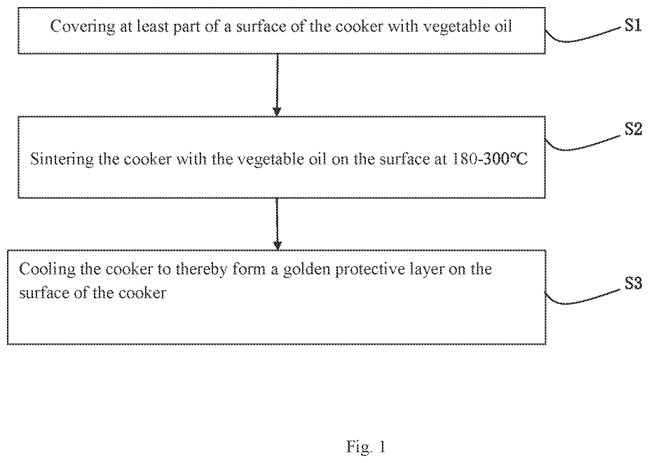

A method of forming the golden protective layer on the cooker according to the present invention will be described in detail with reference to FIG. 1. The method for forming the golden protective layer on the cooker comprises steps S1 to S3.

Step S1, covering at least a part of a surface of the cooker with vegetable oil.

Specifically, the vegetable oil includes linseed oil. The inventor found through research that when the vegetable oil containing the linseed oil and a specific preparation method are used to form a protective layer for protecting the surface of the cooker, the protective layer formed by the linseed oil which has good oil quality, not only has excellent surface protection functions such as oxidation resistance and rust prevention, but also has stronger protection ability under the same conditions. Besides, different from protective layers formed by other vegetable oil or animal oil, the protective layer formed by the vegetable oil containing the linseed oil has a special golden yellow color, giving a better bright and fashionable appearance compared with traditional products. Since no chemical dyestuff, pigment, toner or color paste is added when the golden protective layer is formed, but only the vegetable oil containing the linseed oil is used, no negative impact will be caused to human health during use, and the product is healthier and more environment-friendly.

Alternatively, the vegetable oil can also include one of olive oil, safflower seed oil and soybean salad oil. Adding the olive oil, the safflower seed oil or the soybean salad oil to the linseed oil can adjust the color of the formed golden protective layer, and has little influence on the protective ability, thus forming a golden protective layer with expected chromaticity. The weight ratio of the linseed oil to the olive oil is preferably (7-9): (1-3), more preferably 9:1. The weight ratio of the linseed oil to the safflower seed oil is preferably (8-9): (1-2), more preferably 9: 1, The weight ratio of the linseed oil to the soybean salad oil is preferably (8-9): (1-2), more preferably 9:1.

The cooker is, for example, an iron cooker or a stainless steel cooker. The iron cooker may be, for example, a pure iron cooker or a cooker made of ferroalloy material doped with other elements or substances. The vegetable oil can cover parts or all of the surface of the cooker. Usually, the vegetable oil covers at least a cooking surface of the cooker.

In some embodiments, the vegetable oil covers the surface of the cooker with an oil-immersion method, which specifically comprises: immersing the cooker in vegetable oil with a temperature of 20-40° C. for 1-10 sec, then taking out the cooker, and then preheating the cooker in an environment of 100-190° C. Preferably, the cooker is preheated in the environment of 100-190° C. for 8-15 min, for example, 10 min and 12 min.

Step S2, sintering the cooker with the vegetable oil on the surface at 180-300° C.

Specifically, the cooker with the vegetable oil on the surface can be sintered in a baking oven at, for example, 200° C., 220° C., 240° C., 260° C. and 280° C. Preferably, the cooker with the vegetable oil on the surface is sintered at 180-300° C. for 18-30 min, for example, 20 min, 23 min, 25 min and 27 min. After high-temperature sintering treatment, the internal stress of the cooker is reduced, the stability of an internal structure is improved, and the flexibility of the cooker is enhanced, so that the cooker does not deform or crack and has better applicability and longer service life.

Step S3, cooling the cooker to form the golden protective layer.

Specifically, the sintered cooker is transferred to a cooling chamber where the sintered cooker is cooled to room temperature to form the golden protective layer thereon, and the color of the golden protective layer is, for example, golden yellow, bright yellow, dark yellow, light yellow, bronze or golden yellow with reddish color. Preferably, the golden protective layer has a thickness of 20-60 μm, which makes the golden protective layer have stronger oxidation resistance and rust resistance.

Embodiment 1

Clean the surface of the iron cooker, remove stains and impurities from the surface of the iron cooker, dry the iron cooker, immerse the iron cooker in linseed oil with a temperature of 36° C. for 3 sec, take the iron cooker out from the linseed oil, and then preheat the iron cooker in an environment of 160° C. for 10 min; transfer the preheated iron cooker to a baking oven, and sinter the iron cooker at 270° C. for 20 min; after finishing the sintering step, transfer the iron cooker to a cooling chamber where the iron cooker is cooled to room temperature to foray a golden protective layer with a thickness of 30 μm on the surface of the iron cooker.

Embodiment 2

Clean the surface of the iron cooker, remove stains and impurities from the surface of the iron cooker, dry the iron cooker, immerse the iron cooker in mixed linseed oil and olive oil (mixed with a weight ratio of 9:1) with a temperature of 30° C. for 5 sec, take the iron cooker out from the mixed linseed oil and olive oil, and then preheat the iron cooker in an environment of 150° C. for 10 min; transfer the preheated iron cooker to a baking oven, and sinter the iron cooker at 265° C. for 25 min; after the sintering step, transfer the iron cooker to a cooling chamber where the iron cooker is cooled to room temperature to form a golden protective layer with a thickness of 40 μm on the surface of the iron cooker.

Embodiment 3

Clean the surface of the iron cooker, remove stains and impurities from the surface of the iron cooker, dry the iron cooker, immerse the iron cooker in mixed linseed oil and safflower seed oil with a weight ratio of 9:1 at a temperature of 30° C. for 3 sec, take the iron cooker out from the mixed linseed oil and safflower seed oil, and then preheat the iron cooker in an environment of 180° C. for 10 min; transfer the preheated iron cooker to a baking oven, and sinter the iron cooker at 230° C. for 25 min; and after the sintering step, transfer the iron cooker to a cooling chamber where the iron cooker is cooled to room temperature to form a golden protective layer with a thickness of 45 μm on the surface of the iron cooker.

Embodiment 4

Clean the surface of the iron cooker, remove stains and impurities from the surface of the iron cooker, dry the iron cooker, immerse the iron cooker in mixed linseed oil and soybean salad oil with a weight ratio of 9:1 with a temperature of 35° C. for 5 sec, take the iron cooker out from the mixed linseed oil and soybean salad oil, and then preheat the iron cooker in an environment of 160° C. for 10 min; transfer the preheated iron cooker to a baking oven, and sinter the iron cooker at 260° C. for 25 min; and after the sintering step, transfer the iron cooker to a cooling chamber where the iron cooker is cooled to room temperature to form a golden protective layer with a thickness of 40 μm on the surface of the iron cooker.

Performance Test:

1. Salt spray test: A 5% neutral salt spray test was carried out on the iron cookers with golden protective layers in Embodiments 1 to 4 by the method specified in QB/T 3826-1999. See table 1 for the test duration of the iron cookers.

2. Mechanical dishwashing resistance test: The iron cookers with golden protective layers in Embodiments 1 to 4 were put in a dishwasher, and washed according to the standard procedure, and the number of mechanical dishwashing cycles that the iron cookers could bear was counted, as shown in Table 1.

TABLE 1

| | | Number of | |
|---|---|---|---|
| | | mechanical | Color of |
| | Salt spray test | dishwashing | protective |
| Embodiment | duration/minute | cycles | layer |
| Embodiment 1 | 100-110 | 2 | Golden yellow |
| Embodiment 2 | 80-95 | 2 | Bright yellow |
| Embodiment 3 | 90-100 | 1 | Dark yellow |
| Embodiment 4 | 70-86 | 1 | Bright yellow |

The salt spray test duration of cookers with vegetable oil protective films formed by a traditional process is generally 15-20 min, and the cookers cannot pass the dishwasher test. It can be seen from Table 1 that the salt spray test duration of the cookers with golden protective layers formed by the method of the present invention can be greatly extended to 70-110 min, and the number of mechanical dishwashing cycles can be up to two. The oxidation resistance and rust resistance of the golden protective layer are significantly enhanced, which can greatly prolong the transportation and storage time of the cooker.

It can be seen from the test results of Embodiments 1 to 4 that the olive oil, the safflower seed oil and the soybean salad oil are added to the linseed oil to form the protective layer on the surface of the cooker, and the protective layers with expected chromaticity can be formed this way, while the protective layer made only with the linseed oil on the surface of cooker has a special golden yellow color, which is full, bright and more fashionable, and the formed protective layer has stronger protection ability under the same conditions.

Although the embodiments of the present invention have been shown and described above, it can be understood that the above-mentioned embodiments are exemplary and cannot be understood as limiting the present invention. Without departing from the principles and purposes of the present invention, those skilled in the art can make changes, amendments, substitutions and modifications to the above-mentioned embodiments within the scope of the invention, and all these changes should fall within the protection scope of the Claims of the present invention.

What is claimed is:

1. A method for forming a golden protective layer on a cooker, comprising:
covering at least part of a surface of the cooker with vegetable oil including linseed oil;
sintering the cooker with the vegetable oil on the surface at 180-300° C.; and
cooling the cooker to cause the vegetable oil to form the golden protective layer on the surface of the cooker.

2. The method for forming the golden protective layer on the cooker according to claim 1, wherein sintering the cooker with the vegetable oil on the surface at 180-300° C. comprises sintering the cooker with the vegetable oil on the surface at 180-300° C. for 18-30 min.

3. The method for forming the golden protective layer on the cooker according to claim 1, wherein covering at least part of the surface of the cooker with the vegetable oil comprises:
immersing the cooker in the vegetable oil with a temperature of 20-40° C. for 1-10 sec;
taking the cooker out from the vegetable oil; and
preheating the cooker in an environment of 100-190° C.,

4. The method for forming the golden protective layer on the cooker according to claim 3, wherein preheating the cooker in an environment of 100-190 t comprises preheating the cooker in an environment of 100-190° C. for 8-15 min.

5. The method for forming the golden protective layer on the cooker according to claim 1, wherein the thickness of the golden protective layer is 20-60 μm.

6. The method for forming the golden protective layer on the cooker according to claim 1, wherein the vegetable oil further comprises olive oil, safflower seed oil or soybean salad oil.

7. The method for forming the golden protective layer on the cooker according to claim 6, wherein the vegetable oil further comprises olive oil, and the weight ratio of the linseed oil to the olive oil is (7-9): (1-3).

8. The method for forming the golden protective layer on the cooker according to claim 6, wherein the vegetable oil further comprises safflower seed oil, and the weight ratio of the linseed oil to the safflower seed oil is (8-9): (1-2).

9. The method for forming the golden protective layer on the cooker according to claim 6, wherein the vegetable oil further comprises soybean salad oil, and the weight ratio of the linseed oil to the soybean salad oil is (8-9): (1-2).

10. A cooker with a golden protective layer arranged on a surface thereof, wherein the golden protective layer is formed by the method for forming the golden protective layer on the cooker according to claim 1.

11. The cooker according to claim 10, wherein the cooker is an iron cooker.
